(19) United States
(12) Patent Application Publication
(10) Pub. No.: US 2024/0111563 A1
(43) Pub. Date: Apr. 4, 2024

(54) SECURITY FOR SIMULTANEOUS MULTITHREADING PROCESSORS

(71) Applicant: ADVANCED MICRO DEVICES, INC., Santa Clara, CA (US)

(72) Inventors: David Kaplan, Austin, TX (US); Jelena Ilic, Austin, TX (US)

(21) Appl. No.: 18/088,909

(22) Filed: Dec. 27, 2022

Related U.S. Application Data
(60) Provisional application No. 63/411,921, filed on Sep. 30, 2022.

(51) Int. Cl. G06F 9/455; G06F 9/48

(52) U.S. Cl. CPC G06F 9/45558; G06F 9/4812; G06F 2009/45587

(57) ABSTRACT

A processor implements a simultaneous multithreading (SMT) protection mode that, when enabled, prevents execution of particular software (e.g., a virtual machine) at a processor core when a thread associated with different software (e.g., a different virtual machine or a hypervisor) is currently executing at the processor core. By preventing execution of the software, data, software execution patterns, and other potentially sensitive information is kept protected from unauthorized access or detection. Further, in at least some embodiments the SMT protection mode is implemented on a per-software basis, so that different software can choose whether to implement the protection mode, thereby allowing the processor to be employed in a wide variety of computing environments.

### BACKGROUND

To enhance processing efficiency, some processor architectures support simultaneous multithreading (SMT). In an SMT processor, the architecture allows different executing threads to share hardware resources of the processor. Thus, for example, the hardware resources of a given stage of the processor's instruction pipeline are shared, allowing two different threads to be concurrently executed at the instruction pipeline stage, thus improving throughput at the instruction pipeline and increasing overall processing efficiency. However, SMT processors can present security issues in some computing environments, such as confidential computing environments.

In a confidential computing environment, a processing system (e.g., a server) executes multiple software programs, such as virtual machines and a virtual machine manager (e.g., a hypervisor), wherein different software programs are owned by different entities. For example, in some confidential computing environments, different virtual machines executed by the environment are owned by different companies. Implementation of such an environment with and SMT processor can present security issues, such as exposing the data or operations of one virtual machine, owned by one entity, to another virtual machine, owned by a different entity. While these security issues may be addressed by disabling the processor's SMT capabilities, such an approach limits processing efficiency and overall system flexibility.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a processing system that implements a programmable SMT protection mode in accordance with some embodiments.

FIG. 2 is a block diagram illustrating an example of the processing system of FIG. 1 implementing the SMT protection mode in accordance with some embodiments.

FIG. 3 a block diagram further illustrating an example of the processing system of FIG. 1 implementing the SMT protection mode in accordance with some embodiments.

FIG. 4 is a block diagram illustrating an example of the processing system of FIG. 1 handling an interrupt associated with an idle thread in the SMT protection mode in accordance with some embodiments.

FIG. 5 is a block diagram further illustrating an example of the processing system of FIG. 1 handling an interrupt associated with an idle thread in the SMT protection mode in accordance with some embodiments.

FIG. 6 is a flow diagram illustrating a method of implementing an SMT protection mode at a processor in accordance with some embodiments.

FIG. 7 is a flow diagram illustrating a method of handling an interrupt at a processor in an SMT protection mode in accordance with some embodiments.

### DETAILED DESCRIPTION

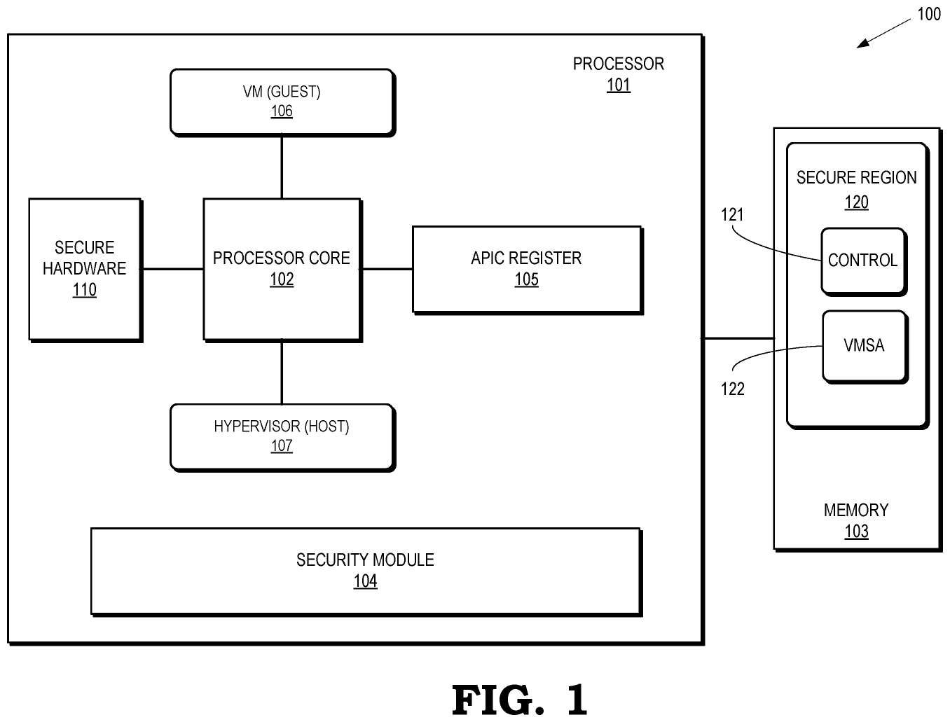

FIGS. 1-7 illustrate techniques for implementing a simultaneous multithreading (SMT) protection mode at a processor. The SMT protection mode, when enabled, prevents execution of particular software (e.g., a virtual machine) at a processor core when a thread associated with different software (e.g., a different virtual machine or a hypervisor) is currently executing at the processor core. By preventing execution of the software, data, software execution patterns, and other potentially sensitive information is kept protected from unauthorized access or detection. Further, in at least some embodiments the SMT protection mode is implemented on a per-software basis, so that different software can choose whether to implement the protection mode, thereby allowing the processor to be employed in a wide variety of computing environments.

To illustrate via an example, in a confidential computing environment, a processor typically executes software owned or controlled by different entities, such as executing different virtual machines owned by different providers of web services. Further, executing different threads associated with differently-owned software with an SMT processor presents potential security vulnerabilities. For example, in some cases a thread executing at an SMT processor core may be able to access data, or identify data access patterns, of another thread concurrently at the same processor core, thus potentially allowing thread associated with malicious thread unauthorized access to confidential information of another entity. One way to address these vulnerabilities is to disable SMT capabilities for the processor. However, such an approach limits overall system flexibility. For example, in many confidential computing environments, the different entities that own or control the different software are likely to have different sensitivity to security concerns, such that simply disabling SMT capabilities does not satisfy all of the different entities. Using the techniques herein, SMT is, in effect, selectively disabled for individual software, such as individual virtual machines, thereby allowing system flexibility to provide different security and performance options for different software.

To illustrate, in some embodiments an SMT processor implements an SMT protection mode, wherein the processor stores programmable security control information (e.g., in a secure region of memory) that indicates, for a given virtual machine (VM), whether the VM is permitted to execute concurrently at the processor with other software. In response to receiving a request to execute the VM (e.g., via reception of a VMRUN command) while a thread associated with different software is executing, processor hardware determines, based on the security control information (sometimes referred to simply as “control information”, if SMT operation is permitted for the VM. If so, the processor executes the VM, concurrently with the executing thread, according to normal SMT operation. Responsive to security control information indicating that SMT operation is not permitted, the processor hardware prevents the VM from executing, and issues a notification (e.g., an error message) to the VM. Because the control information is programmable by the VM, each VM to be executed at the processor is able to individually set whether that VM is able to execute concurrently with threads of other software. Thus, each VM is able to individually control SMT operation for that VM, based on the security and performance needs of the individual VM.

To further enhance system security and flexibility, in some embodiments an SMT processor prevents immediate handling of system events, such as interrupts, for idle threads. To illustrate, in a conventional SMT processor, threads are placed in an idle state under specified conditions, such as when the processor or thread determines that the thread is not currently able to make progress along an instruction path (e.g., when the thread is awaiting data to be loaded from memory). When an interrupt associated with an idle thread (that is, a thread in an idle state) is received, the processor initiates execution (i.e., wakes up) the idle thread to service the interrupt, such as by executing a specified interrupt handler. However, in some cases, servicing the interrupt results in concurrent execution of threads from different software, resulting in potential security issues as described above. Accordingly, using the techniques described here, an SMT processor does not immediately service an interrupt for an idle thread, but instead provides a notification (referred to as a “kick”) to an executing VM. This allows the executing VM to exit execution before the interrupt is serviced, thereby protecting sensitive data or other information.

For example, in some embodiments, in response to receiving, while a VM is executing, an interrupt associated with an idle thread, the processor determines, based on the stored control information, whether SMT operation is permitted for the VM. If so, the processor wakes up the idle thread and services the interrupt. If the control information indicates that SMT operation is not permitted for the VM, the processor hardware does not immediately wake up the idle thread, but instead causes a specified value to be written to a register, such as an Advanced Programmable Interrupt Controller (APIC) register of the processor. In response to the specified value being stored at the register, the processor triggers an inter-processor interrupt (IPI) for the executing VM. Responsive to the IPI, the VM exits execution at the processor, such as by writing any sensitive data to a secure region of system memory, thereby protecting the data. In response to the VM exit, the processor hardware initiates execution of the idle thread, and services the interrupt. Thus, the processor is able to service interrupts of an idle thread while protecting data for a VM that has specified it is not to be executed concurrently with threads of other software.

FIG. 1 illustrates a processing system 100 that implements a programmable SMT protection mode in accordance with some embodiments. The processing system 100 is generally configured to execute sets of instructions (e.g., computer programs) to carry out tasks on behalf of an electronic device. Accordingly, in different embodiments the processing system 100 is part of any of a variety of electronic devices. For purposes of description, it is assumed that the processing system 100 is part of an electronic device that implements a confidential computing environment, such as a server. However, in other embodiments, the processing system 100 is part of a desktop computer, laptop computer, tablet, game console, and the like.

To implement the confidential computing environment, and to execute the sets of instructions, the processing system 100 includes a processor 101 and a memory 103. In some embodiments, the processor 101 is a general-purpose processor, such as a central processing unit (CPU) including hardware structures configured to retrieve and execute the sets of instructions. The memory 103 includes one or more memory devices configured to store and retrieve data based on commands (e.g., store and load commands) received from the processor 101. Accordingly, in different embodiments the memory 103 is random access memory (RAM), non-volatile memory (NVM), hard disc memory, and the like, or any combination thereof.

To execute the sets of instructions, the processor 101 includes a processor core 102, a security module 104, an Advanced Programmable Interrupt Controller (APIC) register 105, and secure hardware 110. It will be appreciated that in some embodiments the processor 101 includes additional hardware to execute instructions, and to execute operations based on those instructions, such as additional processor cores, additional processing units (e.g., one or more graphics processing units), one or more controllers (e.g., memory controllers and input/output controllers), and the like.

The processor core 102 includes one or more instruction pipelines including a plurality of stages to execute instructions in a pipelined fashion. Thus, for example, in some embodiments an instruction pipeline of the processor core 102 includes a fetch stage, a decode stage, a dispatch stage, one or more execution stages (with one or more corresponding execution units), a retire stage, and the like. The processor core 102 also includes, or has access to, memory structures and other hardware (not explicitly illustrated at FIG. 1) that support execution of instructions. For example, in some embodiments the processor core 102 includes or has access to one or more cache structures to store data used for execution of the instructions.

In some embodiments, the processor 101 is an SMT processor. Accordingly, in some embodiments the processor core 102, as well as other hardware of the processor 101, is configured to concurrently execute program threads (referred to herein simply as “threads”) by sharing hardware resources between the concurrently executing threads. For example, in at least some embodiments, different threads concurrently execute at a given stage of an instruction pipeline of the processor core 102 by sharing the hardware resources of that pipeline stage. As another example, in some embodiments different threads concurrently execute at the processor 101 by sharing portions of a cache of the processor core 102. For purposes of description, when two or more threads are concurrently executing at the processor 101, the processor 101 is referred to as being in an SMT mode.

The security module 104 is a set of hardware structures generally configured to create, monitor and maintain a security environment for the processor 101. For example, in at least some embodiments the security module 104 is configured to manage the boot process for the processor 101, initialize security related mechanisms for the processor 101, and monitoring the processing system 100 for suspicious activity or events and implement an appropriate response. In some embodiments the security module 104 includes a microcontroller, a cryptographic coprocessor (CCP) to encrypt and decrypt data, local memory and local registers to store, for example, cryptographic keys, and includes interfaces to interact with the memory 103, the I/O controller of the processor 101, and configuration registers of the processor 101. In some embodiments, the security module 104 includes Environment Management Control hardware that environmental and security checking to ensure that the processor 101 is operating according to specified security parameters.

The secure hardware 110 includes hardware, and associated microcode, of the processor 101 that supports the processor core 102 in executing instructions but is not accessible or modifiable by software executing at the processor core 102. For example, in some embodiments the secure hardware 110 includes hardware that implements finite state machines, hardwired control unit operations, and other hardware that carries out at least some operations generated by the processor core 102, based on the executing instructions. However, the operations of the secure hardware 110 are not accessible or modifiable by the executing software, the secure hardware 110 is able to provide security features in the course of executing operations as described further herein, and without those features being subject to unauthorized modification. For example, the secure hardware 110 is able to control the scheduling of software to be executed at the processor core 102, and in particular control when threads are permitted to concurrently execute at the processor core 102, as described further herein.

As noted above, the processing system 100 is generally configured to implement a confidential computing environment, and in particular to execute a plurality of virtual machines (VMs) (e.g., VM 106), also referred to as guests, and a hypervisor 107, also referred to as a host, to manage execution of the plurality of VMs. Because the different VMs, and at least in some cases the hypervisor 107, are owned by different entities, the processing system 100 implements security features to protect the data of a given VM from access by other software, such as by another VM or by the hypervisor 107. For example, the processing system 100 implements data security for the VMs by implementing a secure region 120 of the memory 103 that stores encrypted data. In particular, the processor 101 is configured to encrypt specified data for each VM according to a corresponding private cryptographic key, and to store the encrypted data at the secure region 120. Because the data is encrypted, the data for one VM is protected from unauthorized access by other VMs and by the hypervisor 107. In at least some embodiments, cryptographic keys for the VMs are managed by the security module 104, and data encryption and decryption for the VMs is executed by a dedicated hardware encryption/decryption module (not shown) at a memory controller (not shown) of the processor 101.

To further illustrate via an example, in the depicted embodiment the secure region 120 stores two blocks of data for the VM 106: control information 121 and a virtual machine storage area (VMSA) 122. The control information 121 stores control information for the VM 106, while the VMSA stores data for the software programs executed by the VM 106. In response to a request to store information by the VM 106 (e.g., in response to a VM exit), the processor 101 encrypts the information, using the cryptographic key associated with the VM 106, and stores the information at the corresponding block (either the control information 121 or the VMSA 122). Similarly, in response to a request to retrieve information from the secure region 120 by the VM 106, the processor 101 retrieves the requested information from the corresponding block, decrypts the information using the cryptographic key associated with the VM 106, and provides the decrypted information to the VM 106.

To provide further security for VM data, the processor 101 is configured to implement a selectable SMT protection mode for executing VMs, wherein a VM that selects the SMT protection mode is not executed concurrently at the processor core 102 with threads of other software. To illustrate via an example, the control information 121 includes programmable control information indicating whether the VM 106 selects the SMT protection mode. In response to a request to execute the VM 106 (e.g., in response to the hypervisor 107 issuing a VMRUN command for the VM 106), the secure hardware 110 first determines whether the processor core 102 is executing at least one thread of different software, such as thread of another VM or of the hypervisor 107. If not, the secure hardware 110 causes the VM 106 to be executed at the processor core 102. For example, if threads of all other VMs and the hypervisor 107 are idle, the secure hardware 110 causes the VM 106 to be executed.

In response to determining that at least one thread of different software is executing at the processor core 102, the secure hardware 110 accesses the control information at the control information 121 to determine whether SMT protection mode is selected for the VM 106. If not, the secure hardware 110 initiates execution of the VM 106 at the processor core 102. That is, the VM 106 is executed in SMT mode, and in particular at least one thread of the VM 106 is executed at the processor core 102 concurrently with the thread of different software, such as a thread of the hypervisor 107 or of another VM.

In response to determining that at least one thread of different software is executing at the processor core 102, and responsive determining that the control information at the control information 121 indicates that SMT protection mode is selected for the VM 106, the secure hardware 110 prevents execution of the VM 106 at the processor core 102, such as by halting execution of the corresponding VM run command. Thus, when SMT protection mode is enabled for a VM, the secure hardware 110 prevents that VM from executing at the processor core 102 concurrently with the thread of different software. In some embodiments, in addition to preventing execution of the VM 106, the secure hardware 110 issues a notification, such as specified error message to the hypervisor 107. In response, the hypervisor 107 performs one or more specified actions, such as waiting a specified amount of time before re-issuing the VMRUN command for the VM 106.

In some embodiments, when a VM is executing in the SMT protection mode, the processor 101 is configured to immediately handle specified system events, such as interrupts, for idle threads. For example, in some embodiments, in response to receiving, while the VM 106 is executing, an interrupt associated with an idle thread (e.g., an idle thread of the hypervisor 107) the secure hardware 110 determines, based on the control information at the control information 121, whether SMT protection is enabled for the VM 106. If not, the secure hardware 110 initiates execution of (wakes up) the idle thread at the processor core 102, which services the interrupt. If the control information indicates that SMT protection is enabled for the VM 106, the secure hardware 110 does not immediately wake up the idle thread, but instead causes a specified value to be written to the APIC register 105. In response to the specified value being stored at the APIC register 105, an APIC controller (not shown) or other portion of the secure hardware 110 triggers an inter-processor interrupt (IPI) for the VM 106. Responsive to the IPI, the VM 106 exits execution at the processor core, including by writing any sensitive information to the control information 121 and the VMSA 122, thereby protecting the information. In response to the VM 106 exit, the secure hardware initiates execution of the idle thread, and services the interrupt.

As noted above, the control information that selects SMT protection mode for a VM is a programmable value, and therefore in some embodiments is programmed by the VM itself. This allows each VM to be executed at the processor 101 to individually select whether to enable SMT protection mode. In other words, in some embodiments at least one VM to be executed at the processor 101 programs its corresponding control information to enable SMT protection mode (so that the VM cannot be executed at the processor 101 concurrent with threads of other software) and at least one other VM to be executed at the processor 101 programs its corresponding control information to disable SMT protection mode (so that the VM is allowed to be executed at the processor 101 concurrent with threads of other software). Further, in at least some embodiments the SMT protection mode control information is stored at the control information block for the VM, at the secure region 120 of the memory 103. The control information is thus protected from unauthorized access and modification by other software, such as by another VM or by the hypervisor 107.

In some embodiments, when a VM has enabled the SMT protection mode, the secure hardware 110 prevents the VM 106 from concurrently executing threads, as described above with respect to a thread of the VM 106 and a thread of the hypervisor 107. That is, when the VM 106 is in the SMT protection mode, the secure hardware 110 ensures that only a single thread of the VM 106 is permitted to execute at the processor core 102, and ensures that any sibling threads, including other threads of the VM 106, are idle before executing a thread of the VM 106. In other embodiments, in the SMT protection mode, the secure hardware 110 allows concurrent execution at the processor core 102 of threads of the same VM, but prevents concurrent execution of threads of different VMs, or of threads of a VM and the hypervisor 107, as described herein.

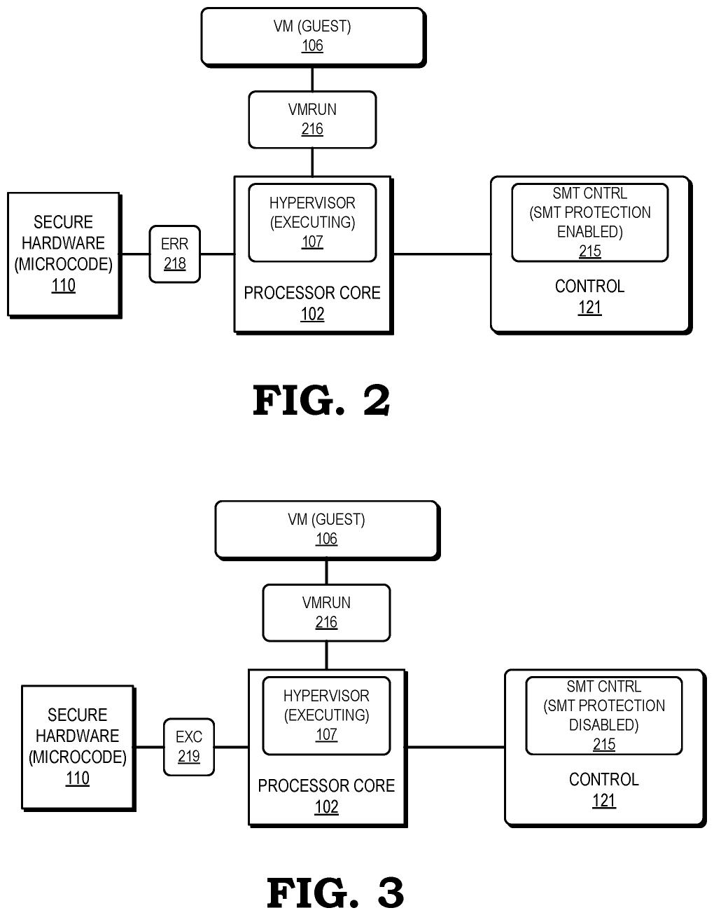

FIG. 2 illustrates an example of the processor 101 operating in the SMT protection mode in accordance with some embodiments. In the illustrated example, the control information 121 for the VM 106 stores SMT control information 215 indicating that SMT protection is enabled for the VM 106. That is, the SMT control information has been programmed (e.g., by the VM 106) to a state that indicates that the VM 106 should not be executed at the processor core 102 concurrent with threads of other software.

As shown at FIG. 2, the processor core 102 is executing a thread of the hypervisor 107. Concurrently, the processor core 102 concurrently receives a VMRUN command 216, indicating a request to execute the VM 106. It will be appreciated that the VMRUN command 216 is illustrated at FIG. 2 as being connected to the VM 106 to show that the VMRUN command 216 is a request to execute the VM 106, but in at least some embodiments the VMRUN command 216 itself is issued by the hypervisor 107.

In response to the processor core 102 receiving the VMRUN command 216, the secure hardware 110 identifies the state of the SMT control information 215, and therefore determines that SMT protection is enabled for the VM 106. Thus, the secure hardware 110 determines that the VM 106 is not to be executed concurrently with threads of different software, including the hypervisor 107. Accordingly, the secure hardware 110 prevents execution of the VMRUN command, so that the VM 106 is not executed. In addition, the secure hardware 110 issues a notification, designated ERR 218, to indicate to the hypervisor 107 that the VM 106 has not been executed. In response, in some embodiments the hypervisor 107 takes remedial action, such as halting execution of other threads at the processor core 102 and re-issuing the VMRUN command 216.

FIG. 3 illustrates an example of the processor 101 operating with the SMT protection mode disabled for the VM 106 in accordance with some embodiments. In the illustrated example, the control information 121 for the VM 106 stores SMT control information 215 indicating that SMT protection is disabled for the VM 106. That is, the SMT control information has been programmed (e.g., by the VM 106) to a state that indicates that the VM 106 is allowed to be executed at the processor core 102 concurrent with threads of other software.

Similar to FIG. 2, in the example of FIG. 3 the processor core 102 is executing a thread of the hypervisor 107. Concurrently, the processor core 102 concurrently receives a VMRUN command 216, indicating a request to execute the VM 106. In response to the processor core 102, the secure hardware 110 identifies the state of the SMT control information 215, and therefore determines that SMT protection is disabled for the VM 106. Thus, the secure hardware 110 determines that the VM 106 is allowed to be executed concurrently with threads of different software, including the hypervisor 107. Accordingly, the secure hardware 110 initiates execution of the VM 106, as indicated by the execution signal EXC 219. The VM 106 is thus executed at the processor core 102 concurrent with the hypervisor 107.

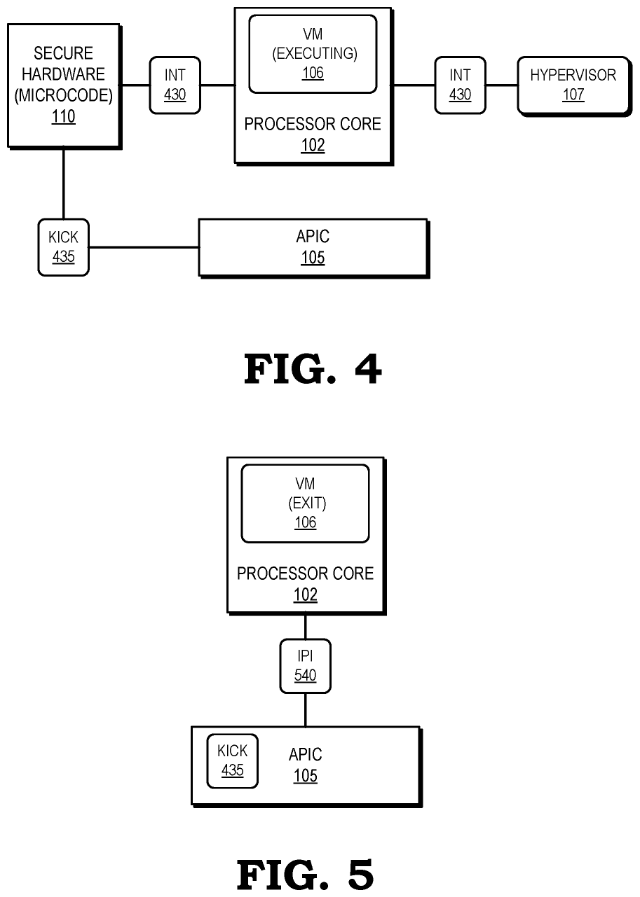

FIG. 4 illustrates an example of the processor 101 handling an interrupt associated with an idle thread when an SMT protected VM is executing, in accordance with some embodiments. In the illustrated example, the VM 106 is executing at the processor core 102. In addition, it is assumed for purposes of the example that the SMT control information 215 indicates that SMT protection is enabled for the VM 106.

As illustrated at FIG. 4, while the VM 106 is executing at the processor core 102, an interrupt 430 associated with the hypervisor 107 is triggered. It will be appreciated that the interrupt 430 is indicated at FIG. 4 as connected to the hypervisor 107 to indicate that the interrupt 430 is triggered to induce service of the interrupt (e.g., by an interrupt handler) by the hypervisor 107. However, in at least some cases the interrupt 430 itself is signaled by another part of the processing system 100, such as by a memory controller, network controller, input/output controller, and the like. In response to receiving the interrupt 430, the secure hardware 110 determines, based on the SMT control information 215, that SMT protection is enabled for the VM 106. In response, the secure hardware 110 does not immediately initiate execution of the hypervisor 107 to service the interrupt, as such execution would result in concurrent execution of the VM 106 and the hypervisor 107 at the processor core 102, in violation of the SMT protection. Instead, the secure hardware 110 writes a specified kick value 435 to the APIC register 105. The kick value 435 indicates that the VM 106 is to exit operation at the processor core 102 so that the interrupt 430 is able to be serviced.

FIG. 5 illustrates an example operation of the processor 101 in response to the kick value 435 being stored, in accordance with some embodiments. In the depicted example, in response to the kick value 435 being stored at the APIC register 105, an APIC controller signals an inter-processor interrupt (IPI) 540 to the processor core 102. In response to the IPI 540, the VM 106 initiates an exit procedure, including writing secure data to the control information 121 and VMSA 122. After the VM 106 exits, the secure hardware 110 initiates execution of the hypervisor 107, which then services the interrupt 430. Thus, in the example of FIGS. 4 and 5, when a VM is designated for SMT protection, an interrupt associated with an idle thread does not trigger immediate execution of the idle thread at a processor core. Instead, a kick value is written to an APIC register to trigger an IPI for the executing VM. This allows the VM to store secure data at a secure region of memory and exit, so that when the idle thread resumes execution, the VM data is not exposed to unauthorized access.

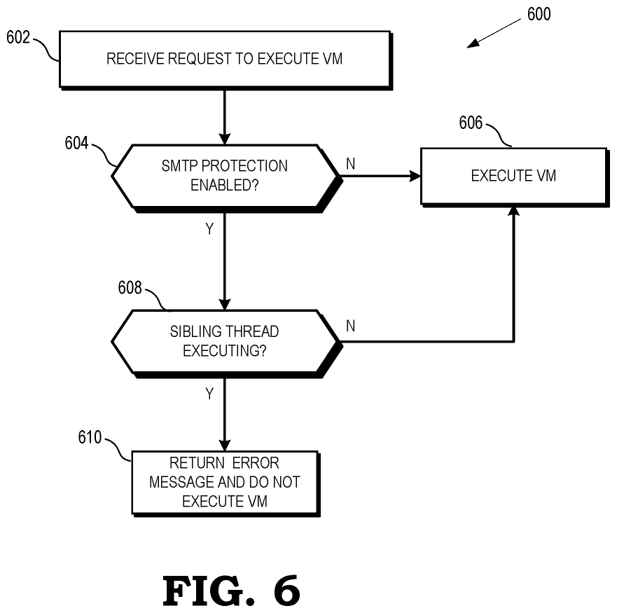

FIG. 6 illustrates a flow diagram of a method 600 of implementing an SMT protection mode in accordance with some embodiments. For purposes of description, the method 600 is described with respect to an example implementation at the processing system 100 of FIG. 1, but it will be appreciated that in other embodiments the method 600 is implemented at a server or other processing system that differs in some respects from the processing system of FIG. 1 but includes at least one SMT processor.

At block 602, the processor core 102 receives a request (e.g., a VMRUN command) to execute the VM 106. In response to the request, at block 604 the secure hardware 110 accesses the control information 121 to determine if the programmable control information indicates that SMT protection mode is enabled for the VM 106. If not (that is, if SMT protection mode is disabled), the method flow moves to block 606 and the secure hardware 110 causes the VM 106 to be executed at the processor 101, concurrent with the thread of other software.

If, at block 604, the secure hardware 110 determines that SMT protection mode is enabled for the VM 106, the method flow proceeds to block 608 and the secure hardware 110 determines if a thread (referred to as a sibling thread) associated with different software (e.g., a thread of a VM different than the VM 106, or a thread of the hypervisor 107) is being executed at the processor core 102. If not, the method flow moves to block 606, and the secure hardware 110 causes the VM 106 to be executed at the processor 101. If, at block 608, the secure hardware 110 determines that a sibling thread is being executed at the processor 101, the method flow moves to block 610 and the secure hardware 110 prevents execution of the VM 106. In addition, the secure hardware 110 issues an error message or other notification to the software (e.g., the hypervisor 107) that issued the request to execute the VM 106.

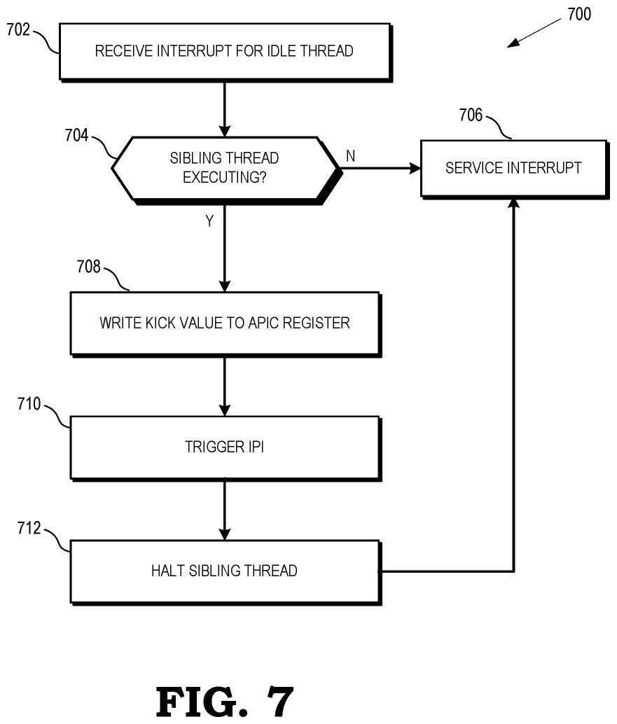

FIG. 7 illustrates a flow diagram of a method 700 of processing an interrupt associated with an idle thread when an SMT protection mode is enabled, in accordance with some embodiments. For purposes of description, the method 700 is described with respect to an example implementation at the processing system 100 of FIG. 1, but it will be appreciated that in other embodiments the method 700 is implemented at a server or other processing system that differs in some respects from the processing system of FIG. 1 but includes at least one SMT processor. It is assumed for purposes of the description of FIG. 7 that SMT protection mode is enabled for any sibling thread being executed at the processor core 102.

At block 702, the processor core 102 receives an interrupt associated with an idle thread. In response, at block 704 the secure hardware 110 determines if a sibling thread (that is a thread of different software than the software associated with the idle thread) is currently being executed at the processor core 102. If not, the method flow proceeds to block 706, and the secure hardware 110 causes the idle thread to be executed (that is, wakes up the idle thread) at the processor core 102, and in particular to service the interrupt.

If at block 704 the determines that a sibling thread is being executed at the processor core 102, the method flow moves to block 708, and the secure hardware 110 writes a specified kick value to the APIC register 105 (because, as noted above, SMT protection mode is enabled for the sibling thread). In response to the kick value being stored at the APIC register 105, at block 710 an APIC controller triggers an IPI. At block 712, execution of the sibling thread is halted responsive to the IPI. The method flow proceeds to block proceeds to block 706, and the secure hardware 110 causes the idle thread to be executed and in particular to service the interrupt.

In some embodiments, certain aspects of the techniques described above may implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method comprising:
in response to receiving, at a simultaneous multithreading (SMT) processor, a request to execute a first virtual machine, identifying whether a first thread is executing at the SMT processor, wherein the first thread is associated with first software different than the first virtual machine; and
in response to identifying that the first thread is executing, preventing execution of the first virtual machine responsive to security control information indicating that SMT protection is enabled for the first virtual machine.

2. The method of claim 1, further comprising:
in response to identifying that the first thread is idle, allowing execution of the first virtual machine.

3. The method of claim 2, further comprising:
in response to identifying that the first thread is executing, allowing execution of the first virtual machine responsive to security control information indicating that SMT protection is disabled for the first virtual machine.

4. The method of claim 1, further comprising:
in response to receiving an interrupt associated with the first software while the first thread is in an idle state and the first virtual machine is executing:
preventing the first thread from executing responsive to the interrupt.

5. The method of claim 4, further comprising:
in response to receiving the interrupt while the first thread is in an idle state and the first virtual machine is executing:
notifying the first virtual machine of the interrupt; and
exiting execution of the first virtual machine in response to the notifying.

6. The method of claim 5, wherein notifying the first virtual machine comprises triggering an inter-processor interrupt (IPI) to the first virtual machine.

7. The method of claim 6, wherein notifying the first virtual machine comprises writing a specified value to a register to trigger the IPI.

8. A method, comprising:
in response to receiving, at a simultaneous multithreading (SMT) processor an interrupt associated with first software while a first thread of the first software is in an idle state:
responsive to determining that a first virtual machine is executing at the processor, preventing the first thread from executing responsive to the interrupt.

9. The method of claim 8, further comprising:
in response to receiving the interrupt while the first thread is in the idle state and the first virtual machine is executing:
notifying the first virtual machine of the interrupt; and
exiting execution of the first virtual machine in response to the notifying.

10. The method of claim 9, wherein notifying the first virtual machine comprises triggering an inter-processor interrupt (IPI) to the first virtual machine.

11. The method of claim 10, wherein notifying the first virtual machine comprises writing a specified value to a register to trigger the IPI.

12. The method of claim 8, wherein preventing the first thread from executing comprises preventing the first thread from executing responsive to an SMT protection mode being enabled for the first virtual machine.

13. The method of claim 12, further comprising executing the first thread responsive to the SMT protection mode being disabled for the first virtual machine.

14. A simultaneous multithreading (SMT) processor comprising:
a processor core to receive a request to execute a first virtual machine; and
secure hardware to:
identify whether a first thread is executing at the SMT processor, wherein the first thread is associated with first software different than the first virtual machine; and
in response to identifying that the first thread is executing, prevent execution of the first virtual machine responsive to security control information indicating that SMT protection is enabled for the first virtual machine.

15. The processor of claim 14, wherein the secure hardware is to:
in response to identifying that the first thread is idle, allow execution of the first virtual machine.

16. The processor of claim 15, wherein the secure hardware is to:
in response to identifying that the first thread is executing, initiate execution of the first virtual machine responsive to security control information indicating that SMT protection is disabled for the first virtual machine.

17. The processor of claim 14, wherein the secure hardware is to:
in response to receiving an interrupt associated with the first software while the first thread is in an idle state and the first virtual machine is executing:
prevent the first thread from executing responsive to the interrupt.

18. The processor of claim 17, wherein the secure hardware is to:
in response to receiving the interrupt while the first thread is in an idle state and the first virtual machine is executing:
notify the first virtual machine of the interrupt; and
exit execution of the first virtual machine in response to the notifying.

19. The processor of claim 18, wherein notifying the first virtual machine comprises triggering an inter-processor interrupt (IPI) to the first virtual machine.

20. The processor of claim 19, wherein notifying the first virtual machine comprises writing a specified value to a register to trigger the IPI.
